(19) United States
(12) Patent Application Publication
(10) Pub. No.: US 2024/0377796 A1
(43) Pub. Date: Nov. 14, 2024

(54) A METHOD AND A SYSTEM FOR ENABLING A USER TO REVIEW SIMULATION DATA OF AN INDUSTRIAL ENVIRONMENT

(71) Applicant: Siemens Industry Software Ltd., Tel Aviv (IL)

(72) Inventor: Moshe Hazan, Elad (IL)

(21) Appl. No.: 18/686,942

(22) PCT Filed: Sep. 1, 2021
(86) PCT No.: PCT/IB2021/057972

§ 371 Date: Feb. 27, 2024

(51) Int. Cl. G05B 17/02

(52) U.S. Cl. CPC G05B 17/02

(57) ABSTRACT

Methods, systems, and computer readable mediums facilitate a concurrent simulation of multiple tasks of a plurality of industrial resources in a virtual environment to enable a user of a first computer-aided reality tool (CAR tool) to review simulation scenario of an industrial environment. The simulation scenario is generated by a second CAR tool having a number of simulation modules for a number of industrial objects on the second computational resource. The second CAR tool is executed and the simulation modules thereby generating for each of the industrial objects a simulation scenario, the simulation scenario is calculated for a period of time wherein the period is subdivided into a number of time intervals wherein the simulation scenario containing for each time interval at least a position value for the object position. The simulation scenario is recorded in a simulation file and the simulation file is played on the first CAR tool.

### TECHNICAL FIELD

The present disclosure is directed, in general, to computer-aided design, visualization, and manufacturing (“CAD”) systems, product lifecycle management (“PLM”) systems, product data management (“PDM”) systems, and similar systems, that manage data for products and other items (collectively, “Product Data Management” systems or PDM systems). More specifically, the disclosure is directed to production environment simulation.

### BACKGROUND OF THE DISCLOSURE

In industrial manufacturing environments, there exist a need to properly orchestrate the execution of the production steps which are contributed by a usually high number of production resources, materials, personnel, conveyors and the like. Usually, a high number of production steps is executed automatically by the proper operation of robots and/or the proper cooperation of robots and humans.

In robotic cells of manufacturing facilities, each physical industrial robot is often required to execute multiple tasks in parallel. Such multiple parallel tasks of a single robot usually consist of one single main robotic motion task and several minor robotic logic tasks. As used herein, the term “motion task” denotes the main robotic task which typically comprises a set of kinematic operations and a set of logic operations. As used herein, the term “logic task” denotes a minor robotic logic task comprising a set of logic operations and no kinematic operation.

The multiple different robotic tasks are executed by the physical robots by running, on their own robotic controllers' threads or processes, corresponding robotic programs on a set of operands. The codes of such robotic programs are usually written in a robotic programming language, usually a native language of the specific robot's vendor and model. Examples of such native robotic languages include, but are not limited by, native robotic languages supported by robot's vendors e.g. like Kuka, ABB, Fanuc. Alternatively, the user can use a CAR tool, like Process Simulate® and others that enable the user to program the robot by 3D objects (locations etc.) and generic OLP command. At download, this data is then converted into the specific controller native code.

Simulation software applications for industrial robots should preferably fulfil the requirement of enabling the simulation of all different multiple tasks performed by the several physical industrial robots on the shop floor.

This requirement is particularly important for virtual commissioning systems which enable production optimizations and equipment validations.

In order to concurrently simulate all the multiple robotic tasks, a simulating system of the general industrial environment is usually required to concurrently execute all the production operations incl. the robot programs of all the plurality of robot controllers of a production environment.

Since today's production cells do comprise more and more robots, the capability of simulating a full robotic cell with real time performances becomes a critical one.

The robotic simulation is expected to be as realistic as possible by mirroring the execution of all the robotic tasks of the involved physical robots and by providing high performances in term of execution time by achieving a virtual time as close as possible to the real time.

In fact, for example, having a high performing simulation execution time is important for enabling synchronizations with the PLC running code and for preventing PLC code's exits with “time out” errors.

Hence, a simulation on the industrial environment, in particular on the robotic simulation application, is required to realistically simulate the behavior of the industrial environment and the multiple robotic tasks of a plurality of robots by executing, in a concurrent and high performing manner, the plurality of main robotic motion programs together with the plurality of sets of robotic logic programs.

For complex industrial cells, having dozens of robots each executing dozens of tasks, this requirement implies running a robotic simulation with high performances for several hundred robotic programs or more.

Nowadays, high performances in simulating such complex robot cells may be achieved by executing hundreds of parallel robotic programs in several CPUs, in clusters of computers or on super computers.

However, today's common scenario is that industrial robotic simulations are mostly executed on computers with common resources rather than on super computers.

Therefore, for cells having a plurality of robots, today's robotic simulations on common computers are typically executed with the help of one or more of the following expedients;
executing only the robotic motion programs, while ignoring robotic logic programs;
executing the robotic motion programs, while manually modeling robotic logic tasks by rewriting their logic programs native codes by using logic blocks;
executing robotic motion programs, while connecting to external Virtual Robot Controllers (“VRCs”) able of executing the robotic logic tasks.

Unfortunately, current robotic simulation techniques on common computers have the drawbacks of being cumbersome and of requiring workarounds, of introducing simulation errors, and/or of not providing realistic and high-performing simulations.

In particular, along the years, in order to have a realistic robotic simulation, the simulation engines of CAR (computer aided reality) applications need to be connected to many add-ons\plug-ins\external application\external configuration files etc. That means that each end user that wants to play a simulation on his machine, needs to install many applications, requires to own the necessary licenses and get the external configuration files. Further beside these rather administrational encumbrances, the user also needs to learn how to install and use each application, even when he does not attend to make any changes in the simulation and just wants to observe the simulation for his individual needs. This is a problematic situation which complicate the CAR tool usage for the non-expert CAR user (considering that the situation is still difficult for users being experts in CAR tool usage).

Improved techniques are therefore desirable.

### SUMMARY OF THE DISCLOSURE

Various disclosed embodiments include methods, systems, and computer readable mediums for facilitating a concurrent simulation of multiple tasks of a plurality of industrial resources in a virtual environment in order to enable a user of a first computer-aided reality tool (CAR tool) being installed on a first computational resource to review simulation scenario of an industrial environment; said simulation scenario being generated by a second computational resource; wherein the following steps are comprised:
a) installing a second CAR tool and a number of simulation modules for a number of industrial objects on the second computational resource, said industrial objects forming the industrial environment;
b) executing the second CAR tool and the simulation modules thereby generating for each of the industrial objects a simulation scenario; said simulation scenario is calculated for a predefined period of time wherein this period is subdivided into a number of predefined time intervals wherein said simulation scenario comprising for each time interval at least a position value for the object position;
c) recording the simulation scenario in a simulation file that comprises for each of the industrial objects entries for the positions value when the position of the industrial object has changed as compared to a position value at a previous time interval;
d) forwarding the simulation file to the first computational resource;
e) playing the simulation file on the first CAR tool being installed on the first computational resource; said first CAR tool also comprising a representation of the industrial environment.

Further preferred embodiment of the present invention are given in the attached dependent claims.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing environment in which an embodiment can be implemented;

FIG. 2 schematically illustrates an overview of the complexity of a CAR tool and the required add-ones\plug-ins\external application\external configuration files etc;

FIG. 3 schematically illustrates the result of the execution of a CAR tool;

FIG. 4 illustrates a flowchart for enabling a user of a first computer-aided reality tool (CAR tool) being installed on a first computational resource to review simulation data of an industrial environment; said simulation data being generated by a second computational resource.

### DETAILED DESCRIPTION

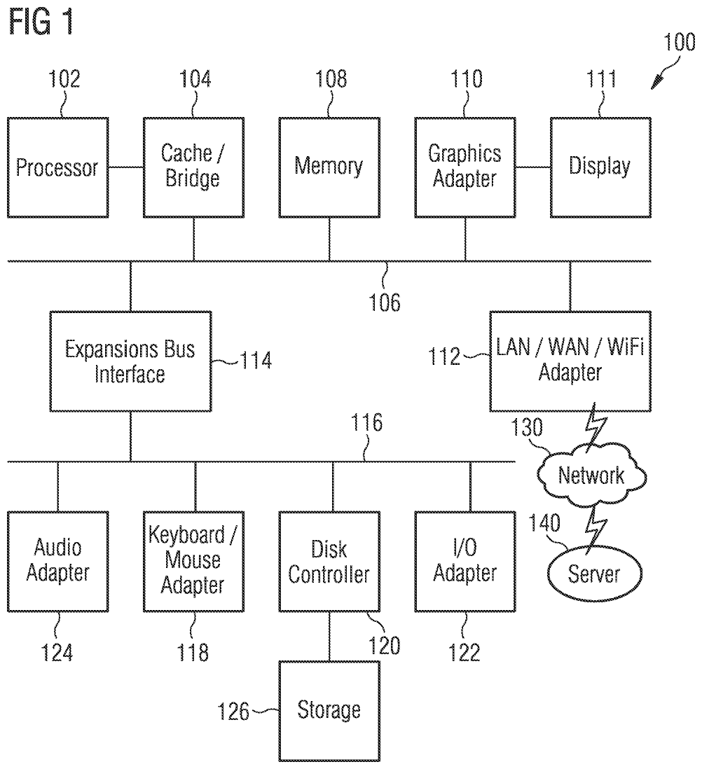

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Previous techniques for facilitating a concurrent simulation of multiple robot tasks have performance drawbacks on common computers. The embodiments disclosed herein provide numerous technical benefits, including but not limited to the following examples.

With embodiments, a virtual simulation system running on a common computer is empowered to concurrently simulate multiple robotic tasks of a plurality of robots with acceptable performances. With embodiments, a virtual simulation system is enabled to realistically simulate the tasks within the industrial environment, and herein particularly the multiple robotic tasks of a plurality of robots in an industrial cell with close to real-time performances.

With embodiments, a virtual simulation system is facilitated to concurrently execute a CAR tool with a number of add-ons\plug-ins\external application\external configuration files etc and multiple robotic programs written in their own original native codes with acceptable real-time performances. Embodiments save CPU time in case of robotic simulations of several concurrent robotic logic programs.

With embodiments, a realistic virtual commissioning simulation is enabled to run on a computer aided reality tool (CAR tool), such as a robotic simulation platform, like e.g. Process Simulate of Siemens Corporation, departing from robotic programs written in their original native coding language.

Embodiments provide encapsulation properties by enabling the whole simulation to run on a simulation platform like Process Simulate without requiring additional-external VRC connections.

FIG. 1 illustrates a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 illustrated can include a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but are not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure can include an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

In an exemplary embodiment, the main algorithm steps for facilitating a concurrent simulation of multiple tasks of a plurality of robots in a virtual environment are illustrated below.

Assume for illustration purposes that this exemplary embodiment refers to a simulation scenario (not shown) of an industrial cell with a plurality of industrial robots, each robot foreseen to concurrently execute different tasks consisting of single motion task and a set of logic tasks, and with a plurality of AGVs, humans, conveyors and the like. The concurrent simulation of the multiple tasks of the robots is performed by concurrently executing the corresponding robotic motion programs and the logic programs of the robots on sets of operands as well as the motion programs for the AGV and conveyors as well as the operational tasks for the humans.

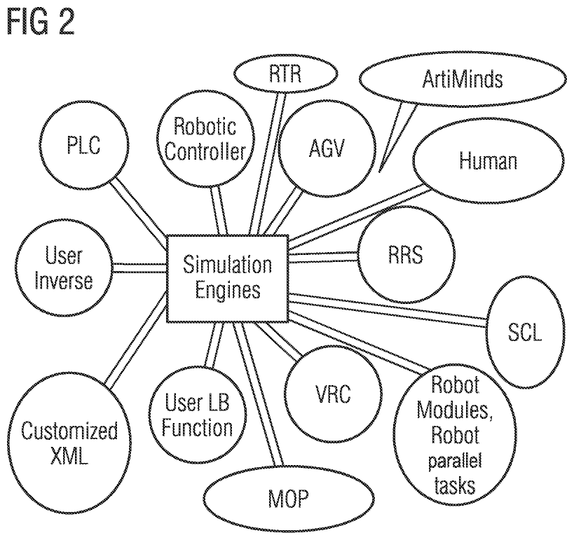

FIG. 2 now schematically shows a data processing environment which centrally comprises a computational resource as simulations engine running a first CAR application that allows to simulate the movements and logic operations of the industrial objects involved in the industrial environment represented by the CAR application. A large number of add-ons\plug-ins\external application\external configuration files etc. are connected to the simulation engine in order to run a full simulation of the complete industrial environment. In the present example, the following add-ones\plug-ins\external application\external configuration files etc. are involved:
PLC—process logic controllers which run the control programs for industrial objects; User Inverse—Instead of out of the box user inverse dll, the user can write his own user inverse dll, which solves the “how this robot can reach this location” task.
Customized XML—Mechanism that allows the user to write XML which represents OLP & Motion commands. Those new commands will be considered and will be used and shown in the CAR tool, and will be part of simulation & download.
User LB function—Logic block section that are written by the end user of the simulations engine
MOP—Default motion planner tool
VRC—Virtual robot controller, like Robot Studio etc. which are provided by the robotic vendors
Robot Modules, Robot parallel tasks
SCL—Simulation Control Logic
VRC—Virtual Robotic Controller
RRS—Realistic Robot Simulation which is—unlike MOP, a more accurate motion planner per robot controller
Human—data set comprising the operative task for humans and trajectories during the execution of the operative tasks
AGV—control data for the automated guided vehicles defining their trajectories and stops and the like
ArtiMinds—Tool from a specific company which supplies robotic motion services
RTR—Real-time Robotic tool which is an external motion planner based on hardware.

Once these add-ones\plug-ins\external application\external configuration files etc. are installed and thus provide their respective simulation information to the simulation engine, the simulation engine can execute a full simulation of the industrial scenario for a given period of time while this period of time is subdivided into a pre-defined number of time intervals. The present invention here appreciates to use the simulation outcome of all those external modules which, from simulation point of view, are position data and signals related to each of the simulated behavior of the industrial objects and related to the end of each simulation step which lasts one time interval. Thus, one records this data outcome (position data—mandatory, signals—optional, simulation log—optional).

At this stage, it si important to emphasize that unlike any other recorder the present invention does record the complete simulation in terms of a complete movie that is showing what happens on each module at all. Further, the present invention does not record any simulation activity even if it affects the simulated objects. The present invention only records at the end of each time interval the final results of the simulation into the simulation file that can be re-played later on by a different user.

Thus, this leads to a simulation file that just contains an entry for at least the position of an industrial object when the position of the industrial object has changed as compared to a position value at a previous time interval. Thus, during the simulation, the CAR tool does not need to record each plugin application but collects in the simulation file for each time interval the final simulation outcome results that was changed this time interval. Thus, the simulation file will comprise at least the following entries:

For each part: the position of the part;
For each industrial resource, such as LB, Robot, AGV, Conveyor, Human etc.: the position of the industrial resource, optional entries here are the joint values, resource Input signals and resource Output signals;
Further, the simulation file may additionally comprise for each PLC: External Connection Input signals and External Connection Output signals. Furthermore, the simulation file may comprise the log of the simulation, any events from the collision detection along the simulation and other pre-defined events along the simulation.

This simulation file can then be transferred to another computational resource comprising also an installed CAR tool that is aware of the industrial environment on which the full simulation has been executed.

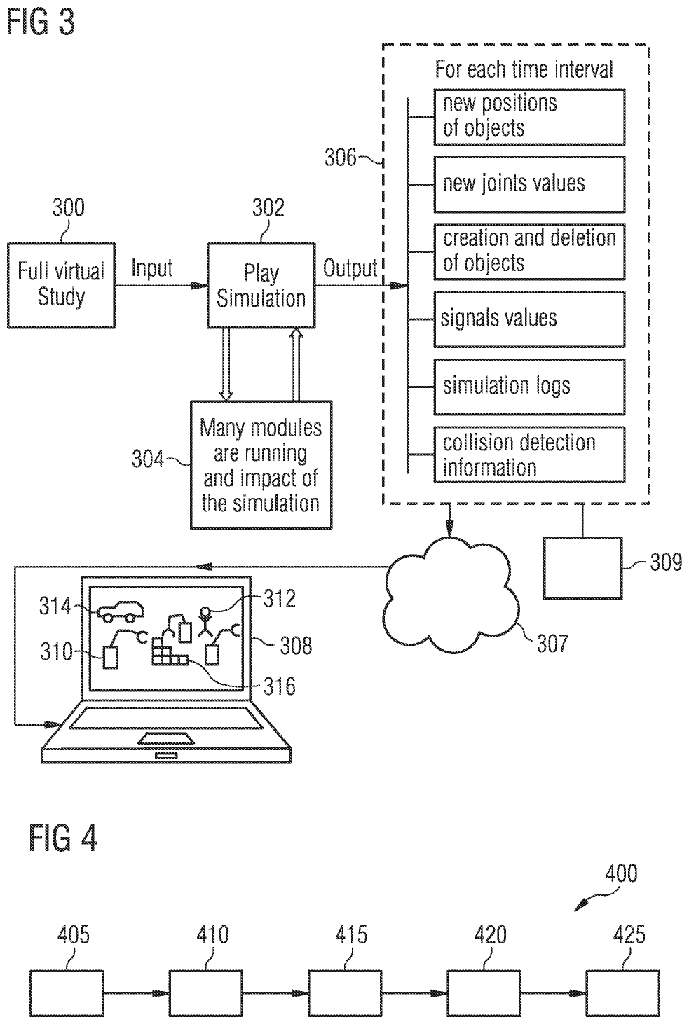

FIG. 3 illustrates schematically the process of running a full simulation on the industrial scenario which comprises usually a number of resources, such as machines, robots, material, conveyors and human operators. This industrial scenario is provided for the full virtual study 300 as input data for the CAR tool 302 (simulations engine) that runs the simulation thereby using input data from and providing output data to a number of modules 304 (add-ons\plug-ins\external application\external configuration files etc.) as they are for example explained with reference to FIG. 2. The full simulation is executed for a predefined period of time that is subdivided into a number of time intervals. These time intervals typically may have depending on the scope of the full simulation a length of a few ms up to 500 ms. For each time interval, the results of the simulation are recorded in a simulation file 306 that mandatorily comprises the time stamp (or the indication for the specific time interval) and the position data for the industrial objects that are comprised in the industrial scenario forming the basis for the full simulation process. Here, an object only receives a new entry for its position in the simulation file 306 when its position as compared to the previous time interval has changed. As shown in FIG. 3, the simulation file 306 further comprises also data entries for the new joints values, for the creation and deletion of objects, for signals values for input and output, for example, to PLCs, data for the simulation log and information on collision detection, for example for a number of robots acting within the same field of operation.

According to the settings that are made by the operator of the simulation engine, this full simulation can be repeated for several simulation cases which, for example, may comprise different motion planners and/or different time intervals and/or different HMI start input and/or different number of programs, add-ons\plug-ins\external application\external configuration files etc to be executed during the simulation case. Each simulation provides as result the simulation file 306 that can be recorded in a library or on the cloud (simulation as a service SaaS).

Now, these simulation files 306 can be shared with other users which do not have the license/installation/external files to run the full simulation. The simulation file 306 can be forwarded into a cloud 307 and/or a library 309. Another computation resource 308 (i.e. other than the one that run the full simulation case) can then download the simulations file 306 from the cloud 307 and/or the library 309. This computation resource 308 also comprises a CAR tool and uses now the simulation file 306 to play the results stored in the simulation file 306 for the industrial scenario, such as robots 310, humans 312, AGVs 314 and parts 316. Of course, this user can now only play the simulations case as it is stored in the simulations file 306. This simulation file 306 can be displayed on this CAR tool very fast since the display of the simulation file 306 does not require a calculation to achieve the simulation results since the simulation file 306 provides the data of the simulation result.

In this mode, the user of the computation resources 308 does not need to use any simulation calculation (even no MOP or other internal simulation component). He can just read the relevant recorded information in the simulation file 306 and apply the changes, for example in the positions of the objects, to his CAR tool for each part, resource and signal that he would like to see in his “play-back” review. In this mode, the simulation shown on the computations resources 308 is totally based on the information recorded in the simulation file 306 only and, thus, is not a true simulation but a play-back of the stored data in the simulation file 306.

From the user point of view, he sees a full simulation. He can see all parts and resources, zoom and focus (since it is not a movie), sees all signals, logs etc. Nonetheless, the present invention does not store the complete (input/output) data of the simulation study data itself but just the new positions and values, thus leading to a recorded simulation file that is very small, even for a long simulation study (period). Hences, also the user that will play the simulations file just needs to load the same rather small data file before he can play the simulations file. Still, even considering the lean volume of the simulation file, the user can play back, and still use many CAR commands and viewers, blanks and zoom it and out etc.

FIG. 4 illustrates a flowchart 400 of a method for enabling a user of a first computer-aided reality tool (CAR tool) being installed on a first computational resource to review a simulation scenario of an industrial environment; said simulation scenario being generated by a second CAR tool on a second computational resource. Such method can be performed, for example, by system 100 of FIG. 1 described above, but the “system” in the process below can be any apparatus configured to perform a process as described and can be generically named a computations resource.

In the virtual environment, a number of industrial objects are foreseen that form an industrial environment, such as an manufacturing environment in the car manufacture industry, discrete manufacturing industry, food and beverage industry, life science and pharma industry etc. In the real industrial process, these industrial objects collaborate together by use of appropriate control data in order to achieve the intended result in terms of manufacturing, material handling etc.

At act 405, the method for enabling a user of a first computer-aided reality tool (CAR tool) being installed on a first computational resource to review a simulation scenario of an industrial environment; said simulation scenario being generated by a second CAR tool on a second computational resource starts with the step of installing a second CAR tool and a number of simulation modules for a number of industrial objects on the second computational resource, said industrial objects forming the industrial environment.

Once all the modules required for a full simulation of the industrial environment are present in the second computational resource, at act 410 the second CAR tool and the simulation modules are executed thereby generating for each of the industrial objects a simulation scenario; said simulation scenario is calculated for a predefined period of time wherein this period is subdivided into a number of predefined time intervals wherein said simulation scenario comprising for each time interval at least a position value for the object position.

At act 415, the simulation scenario is recorded in a simulation file that comprises for each of the industrial objects entries for the positions value when the position of the industrial object has changed as compared to a position value at a previous time interval.

At act 420, the simulation file is forwarded to the first computational resource. Of course, this forwarding includes that the second computational resource stores the simulation file in a library or in a cloud from where the first computational resource can download the simulation file.

At act 425, the simulation file is played on the first CAR tool that is installed on the first computational resource; said first CAR tool also comprising a representation of the industrial environment. Thus, the user of the first computational resources can see the simulation of the industrial object according to the data stored in the simulation file.

In embodiments, the simulation file can further comprise for each of the industrial object one or more of the following values:
a) new joint values;
b) indicator for creation or deletion of one or more of the industrial objects;
c) input and/or output values of the industrial object;
d) simulation log data; and/or
e) collision detection information.

Further, the simulation file may comprise for each of the industrial object only then an entry when the value has changed as compared to an earlier value taken at an earlier time interval.

Furthermore, the first CAR tool might be enabled to selectively play the simulation file for a number of selectable industrial objects and/or for a selectable time period and/or wherein the second CAR tool might be enabled to selectively record and/or play the simulation file for a number of selectable industrial objects and/or for a selectable time period. Here, the user can select to see the simulation results only for a selectable number of industrial objects and/or for a selectable time period on the re-play side while the user on the record side can also run a simulation scenario only for a selectable number of industrial objects and/or for a selectable time period.

Typically, the industrial objects can be selected from a group of industrial objects, comprising Robots, Parts, Operators, AGVs, controllers and the like.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims.

1-15. (canceled)

16. A method for enabling a user of a first computer-aided reality tool (CAR tool) being installed on a first computational resource to review a simulation scenario of an industrial environment, the simulation scenario being generated by a second CAR tool on a second computational resource, the method comprises the following steps of:
installing the second CAR tool and a plurality of simulation modules for a plurality of industrial objects on the second computational resource, the plurality of industrial objects forming the industrial environment;
executing the second CAR tool and the simulation modules thereby generating for each of the industrial objects a simulation scenario, the simulation scenario is calculated for a predefined period of time wherein the predefined period of time is subdivided into a plurality of predefined time intervals wherein the simulation scenario containing for each of the predefined time intervals at least a position value for an object position;
recording the simulation scenario in a simulation file that contains for each of the industrial objects entries for position values when a position of the industrial object has changed as compared to the position value at a previous time interval;
forwarding the simulation file to the first computational resource; and
playing the simulation file on the first CAR tool being installed on the first computational resource, the first CAR tool also containing a representation of the industrial environment.

17. The method according to claim 16, wherein the simulation file further comprises for each of the industrial objects at least one of the following values:
new joint values;
an indicator for creation or deletion of at least one of the industrial objects;
input and/or output values of the industrial object;
simulation log data; and/or
collision detection information.

18. The method according to claim 17, wherein the simulation file contains for each of the values only then an entry when a value has changed as compared to an earlier value taken at an earlier time interval.

19. The method according to claim 16, wherein the first CAR tool is enabled to selectively play the simulation file for a number of selectable industrial objects and/or for a selectable time period and/or wherein the second CAR tool is enabled to selectively record and/or play the simulation file for the number of selectable industrial objects and/or for the selectable time period.

20. The method according to claim 16, wherein the industrial objects are selected from a group of industrial objects consisting of: robots, parts, operators, automated guided vehicles, and controllers.

21. A data processing environment, comprising:
a first computer-aided reality tool, hereinafter CAR tool, being installed on a first computational resource;
a second CAR tool being installed on a second computational resource;
a data network connecting said first computational resource to said second computations resource and vice versa;
the data processing environment configured to enable a user of said first CAR tool installed on said first computational resource to review a simulation scenario of an industrial environment;
the simulation scenario being generated by said second computational resource and specifically enabled to:
install said second CAR tool and a plurality of simulation modules for a plurality of industrial objects on said second computational resource, the industrial objects forming the industrial environment;
execute said second CAR tool and the simulation modules thereby generating for each of the industrial objects the simulation scenario, the simulation scenario is calculated for a predefined period of time wherein the predefined period of time is subdivided into a plurality predefined time intervals wherein said simulation scenario containing for each of the predefined time intervals at least a position value for an object position;
record the simulation scenario in a simulation file that contains for each of the industrial objects entries for position values when the position of the industrial object has changed as compared to the position value at a previous time interval;
forward the simulation file to said first computational resource; and
play the simulation file on said first CAR tool being installed on said first computational resource, said first CAR tool also containing a representation of the industrial environment.

22. The data processing environment according to claim 21, wherein the simulation file further comprises for each of the industrial objects at least one of the following values:
new joint values;
an indicator for creation or deletion of at least one of the industrial objects;
input and/or output values of the industrial objects;
simulation log data; and/or
collision detection information.

23. The data processing environment according to claim 22, wherein the simulation file contains for each of the values only then an entry when a value has been changed as compared to an earlier value taken at an earlier time interval.

24. The data processing environment according to claim 21, wherein said first CAR tool is enabled to selectively play the simulation file for a number of selectable industrial objects and/or for a selectable time period and/or wherein said second CAR tool is enabled to selectively record and/or play the simulation file for the number of selectable industrial objects and/or for the selectable time period.

25. The data processing environment according to claim 21, wherein the industrial objects are selected from a group of industrial objects consisting of: robots, parts, operators, automated guided vehicles, and controllers.

26. A non-transitory computer-readable medium encoded with executable instructions that, when executed, cause a data processing environment for enabling a user of a first computer-aided reality tool (CAR tool) being installed on a first computational resource to review a simulation scenario of an industrial environment, the simulation data scenario being generated by a second computational resource, the executable instructions performing a method comprising:
installing a second CAR tool and a plurality of simulation modules for a plurality of industrial objects on the second computational resource, the industrial objects forming the industrial environment;
executing the second CAR tool and the simulation modules thereby generating for each of the industrial objects a simulation scenario, the simulation scenario is calculated for a predefined period of time wherein the predefined period of time is subdivided into a plurality of predefined time intervals wherein the simulation scenario containing for each of the predefined time intervals at least a position value for an object position;
recording the simulation scenario in a simulation file that contains for each of the industrial objects entries for position values when an object position of an industrial object has changed as compared to the position value at a previous time interval;
forwarding the simulation file to the first computational resource; and
playing the simulation file on the first CAR tool being installed on the first computational resource, the first CAR tool also containing a representation of the industrial environment.

27. The non-transitory computer-readable medium according to claim 26, wherein the simulation file further contains for each of the industrial objects at least one of the following values:
new joint values;
an indicator for creation or deletion of one or more of the industrial objects;
input and/or output values of the industrial objects;
simulation log data; and/or
collision detection information.

28. The non-transitory computer-readable medium according to claim 27, wherein the simulation file contains for each of the values only then an entry when the value has been changed as compared to an earlier value taken at an earlier time interval.

29. The non-transitory computer-readable medium according to claim 26, wherein the first CAR tool is enabled to selectively play the simulation file for a plurality of selectable industrial objects and/or for a selectable time period and/or wherein the second CAR tool is enabled to selectively record and/or play the simulation file for the plurality of selectable industrial objects and/or for the selectable time period.

30. The non-transitory computer-readable medium according to claim 26, wherein the industrial objects are selected from a group of industrial objects consisting of: robots, parts, operators, automated guided vehicles, and controllers.
